(19) United States
(12) Patent Application Publication
(10) Pub. No.: US 2012/0232196 A1
(43) Pub. Date: Sep. 13, 2012

(54) UV-STABLE POLYCARBONATE COMPOSITION HAVING IMPROVED PROPERTIES

(75) Inventors: Stephan Konrad, Dormagen (DE); Helmut Werner Heuer, Leverkusen (DE); Karl-Heinz Köhler, Aachen-Brand (DE); Rolf Wehrmann, Krefeld (DE); Daniel Koch, Shanghai (CN); Marc Buts, Duffel (BE); Frank Guldentops, Shanghai (CN)

(73) Assignee: Bayer MaterialScience AG, Leverkusen (DE)

(21) Appl. No.: 13/498,361

(22) PCT Filed: Sep. 17, 2010
(86) PCT No.: PCT/EP10/05726

§ 371 Date: Apr. 24, 2012

(30) Foreign Application Priority Data
Sep. 30, 2009 (DE) 10 2009 043 511.5

(51) Int. Cl. C08K 5/50; C08L 69/00; C08K 5/521; C08K 5/3475; C08K 5/3492

(52) U.S. Cl. 524/91; 524/154; 524/100; 524/140

(57) ABSTRACT

The invention relates to a UV-stabilised melt polycarbonate composition having improved melt flowability while at the same time having good optical properties and at the same time good hydrolytic stability, the composition comprising a melt polycarbonate, at least one UV absorber, at least one phosphine and optionally an aliphatic carboxylic acid ester.

The invention relates to a UV-stabilised melt polycarbonate composition having improved melt flowability while at the same time having good optical properties and at the same time good hydrolytic stability, which composition additionally comprises heat stabilisers and optionally also aliphatic fatty acid esters.

The production of injection-moulded polycarbonate parts, in particular in the case of thin-wall mouldings, requires a sufficiently high melt flowability for the injection-moulding operation to take place without problems. Depending on the field of use, such mouldings are exposed to a very wide variety of environmental conditions and must meet a large number of demands without problems. This means that, in addition to the processing properties, it is necessary to ensure in particular that the polycarbonate has the conventional good optical properties while at the same time being stable to UV radiation. Moreover, these good properties must not change under the influence of moisture, which occurs relatively frequently, even at a relatively high temperature.

Polycarbonate that is prepared in the melt by the so-called melt transesterification process, also known as the melt process, from organic carbonates, for example diaryl carbonates, and bisphenols, without the use of additional solvents, is becoming increasingly important economically and is therefore a suitable material for many fields of use. A particular advantage of melt polycarbonates is that, owing to the solvent-free preparation process, the content of volatile compounds is minimised from the outset.

The preparation of aromatic polycarbonates by the melt transesterification process is known and is described, for example, in Schnell, “Chemistry and Physics of Polycarbonates”, Polymer Reviews, Vol. 9, Interscience Publishers, New York, London, Sydney 1964, in D.C. Prevorsek, B. T. Debona and Y. Kersten, Corporate Research Center, Allied Chemical Corporation, Morristown, N.J. 07960, “Synthesis of Poly(ester)carbonate Copolymers” in Journal of Polymer Science, Polymer Chemistry Edition, Vol. 19, 75-90 (1980), in D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718, and finally in Des. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

Melt polycarbonates which contain conventional additives and which differ from polycarbonates prepared with phosgene in solution in respect of the OH end group content and in respect of the defect structures in the polycarbonate polymer chain are described, for example, in US-2005-0261460 A1. That specification discloses a process for the catalysis of the melt transesterification reaction for the preparation of melt polycarbonate with minimal defect structures, such as are formed, for example, by Fries rearrangement, and with a minimal OH end group content. However, it does not contain any information as to how the mixtures of such melt polycarbonates with the polymer additives mentioned therein, for example UV absorbers, heat stabilisers and demoulding aids, behave in respect of the property combinations of processability, hydrolytic stability and optical quality. Nor is there any indication of preferred combinations of the mentioned polymer additives.

JP-2003-119369 discloses polymer mixtures of melt polycarbonates with UV absorbers and phosphites as heat stabilisers. These polymer mixtures, whose melt polycarbonates can contain a large number of different defect structures, in particular branches, in the polymer chain, have improved resistance to weathering, improved optical properties and improved processing properties in respect of blow forming and extrusion behaviour. The profile of requirements for this type of processing differs, however, from the requirements for processing by injection moulding in respect of the flowability of the polymer melt. The melt flowability for blow forming or for extrusion of polymer melts is typically achieved very easily by branched polymers but is in most cases unsuitable for processing by injection moulding, which requires a higher melt flowability of the polymer mixture with, at the same time, adequate strength. No references to this are to be found in this application. Nor are any further additives for solving such a problem disclosed.

JP-2001-089653 discloses polymer mixtures of melt polycarbonates with UV stabilisers, phosphorus oxide compounds and demoulding agents, which mixtures have improved heat stability, good transparency and good hydrolytic stability and resistance to weathering. No information is given regarding the rheology of the polymer melts or their processability in the injection moulding process.

JP-2004-352829 likewise discloses polymer mixtures of optionally melt polycarbonates with UV absorbers, phosphites and paraffins or fatty acid esters, which mixtures, as well as having good UV stability, also exhibit improved hydrolytic stability and resistance to weathering, good temperature stability and good colour stability. Here too, it cannot be seen whether and in what way the melt flowability is positively affected in the case of processing by the injection moulding process.

The known prior art accordingly gives no indication of how the hydrolytic stability, the melt flowability in the case of processing by injection moulding and, at the same time, the optical properties of UV-protected melt polycarbonates are to be improved.

It was therefore an object of the invention to provide UV-protected melt polycarbonate compounds which exhibit good hydrolytic stability while at the same time having good melt flowability and at the same time good optical properties.

Surprisingly, it has now been found that melt polycarbonates containing a combination according to the invention of UV absorber with specific organic phosphines and optional aliphatic carboxylic acid esters have improved melt flowability, UV stability and good optical properties.

The above-mentioned disadvantages of the prior art are solved by the melt polycarbonate moulding compositions according to the invention, which contain as UV stabilisers compounds from the substance class of the benzotriazoles, triazines, malonic acid alkyl esters or cyanoacrylic acid esters and which contain as phosphorus compounds a mixture of phosphines and optionally alkyl phosphates.

The aliphatic carboxylic acid esters which are optionally additionally present in the moulding compositions are esters of aliphatic C₆-C₃₂-carboxylic acids with mono- or poly-valent aliphatic and/or aromatic hydroxy compounds. The moulding compositions according to the invention, while having good UV stability, are distinguished by improved melt flowability in the case of processing by injection moulding and at the same time have good optical properties, in particular a good intrinsic colour after processing by injection moulding, and good hydrolytic stability.

The compositions according to the invention containing melt polycarbonates with the phosphines according to the invention surprisingly exhibited an improvement in the mentioned combination of properties of hydrolytic stability, melt flowability and optical properties, while compositions from comparison tests with the phosphites conventionally used in the prior art remained markedly behind the compositions according to the invention in terms of their properties, at least one of the three properties being markedly poorer, as is shown by the comparison of the examples according to the invention with the comparison examples in Tables 1 to 4.

The invention accordingly provides a polycarbonate composition comprising a melt polycarbonate, prepared from carbonic acid diaryl ester and bisphenols in the melt, which, as well as containing the mentioned UV absorbers, additionally comprises phosphines and optionally alkyl phosphates and/or aliphatic carboxylic acid esters.

Phosphines A) that are used according to the invention are compounds of the general formula (I):

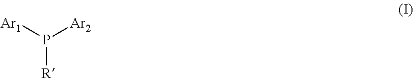

wherein Ar₁ and Ar₂ are identical or different unsubstituted or substituted aryl radicals and
R′ is an unsubstituted or substituted aryl radical or one of the following radicals (1a) to (Ih)

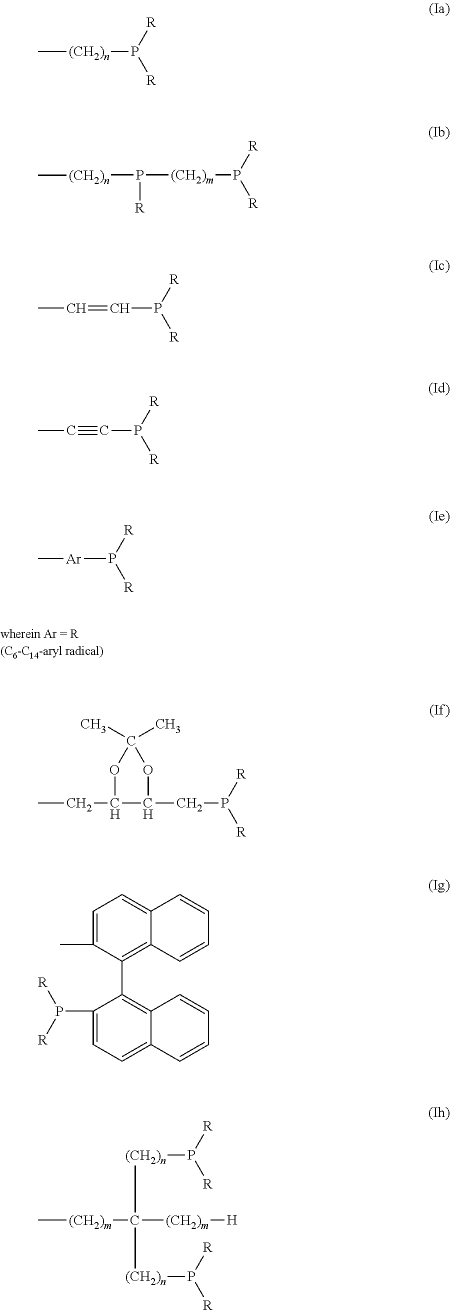

in which R is an unsubstituted or substituted C₆-C₁₄-aryl radical and n and m each independently of the other is an integer from 1 to 7 and wherein the hydrogen atoms of radicals (Ia) to (Ic) can also be replaced by substituents, and wherein

R′ can also be 4-phenyl-phenyl or α-naphthyl when both Ar radicals in formula (I) are likewise 4-phenyl-phenyl or α-naphthyl. The 4-phenyl-phenyl and α-naphthyl radicals can also carry substituents.

Preferred radicals Ar in (I) are phenyl, 4-phenyl-phenyl and naphthyl.

Suitable substituents of the aryl radicals Ar in (I) are F, CH₃, Cl, Br, I, OCH₃, CN, OH, alkylcarboxy, phenyl, cycloalkyl, alkyl.

Suitable substituents for the hydrogen atoms of radicals (Ia) to (Ic) are F, CH₃, alkyl, cycloalkyl, Cl, aryl.

Preferred numbers “n” and “m” are 1, 2, 3 or 4.

Aryl in each case independently represents an aromatic radical having from 4 to 24 skeleton carbon atoms, in which none, one, two or three skeleton carbon atoms per ring (aromatic ring of carbon atoms), but at least one skeleton carbon atom in the molecule as a whole, can be substituted by heteroatoms selected from the group nitrogen, sulfur and oxygen. Preferably, however, aryl denotes a carbocyclic aromatic radical having from 6 to 24 skeleton carbon atoms. The same applies to the aromatic moiety of an arylalkyl radical as well as to aryl constituents of more complex groups (e.g. aryl-carbonyl or aryl-sulfonyl radicals).

Examples of C₆-C₂₄-aryl are phenyl, o-, p-, m-tolyl, naphthyl, phenanthrenyl, anthracenyl or fluorenyl; examples of heteroaromatic C₄-C₂₄-aryl in which none, one, two or three skeleton carbon atoms per ring, but at least one skeleton carbon atom in the molecule as a whole, can be substituted by heteroatoms selected from the group nitrogen, oxygen and sulfur are, for example, pyridyl, pyridyl N-oxide, pyrimidyl, pyridazinyl, pyrazinyl, thienyl, furyl, pyrrolyl, pyrazolyl, imidazolyl, thiazolyl, oxazolyl or isoxazolyl, indolizinyl, indolyl, benzo[b]thienyl, benzo[b]furyl, indazolyl, quinolyl, isoquinolyl, naphthyridinyl, quinazolinyl, benzofuranyl or dibenzofuranyl.

Triarylphosphines which are suitable according to the invention are, for example, triphenylphosphine, tritolylphosphine, tri-p-tert-butylphenylphosphine or their oxides. Triphenylphosphine is preferably used as the triarylphosphine.

Examples of diarylphosphines which can be used according to the invention are 1,2-bis-(di-pentafluorophenyl-phosphino)-ethane,

bis-(diphenyl-phosphino)-acetylene,

1,2-bis-(diphenylphosphino)-benzene,

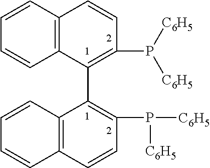

[2,2′-bis-(diphenylphosphino)-1,1′-binaphthyl],

2,3-bis-(diphenylphosphino)-butane,

1,4-bis-(diphenylphosphino)-butane,

1,2-bis-(diphenylphosphino)-ethane,

cis-1,2-bis-(diphenylphosphino)-ethylene,

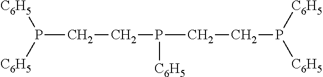

[bis-(2-(diphenylphosphino)-ethyl)-phenylphosphine], bis-(diphenylphosphino)-methane, 2,4-bis-(diphenylphosphino)-pentane, 1,3-bis-(diphenylphosphino)-propane,

1,2-bis-(diphenylphosphino)-propane,

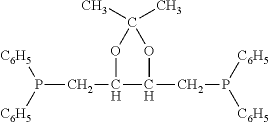

[4,5-O-isopropylidene-2,3-dihydroxy-1,4-bis-(diphenylphosphino)-butane], tri-(4-diphenyl)-phosphine and

tris-(cz-naphthyl)-phosphine.

The diarylphosphines can be prepared according to the following literature references:

Issleib et al., Chem. Ber., 92(1959), 3175, 3179 and Hartmann et al., Zeitschr. Anorg. Ch. 287(1956) 261, 264.

It is also possible to use mixtures of different phosphines. The phosphines that are used are employed in amounts of from 10 to 2000 mg/kg, preferably from 50 to 800 mg/kg, particularly preferably from 100 to 500 mg/kg, based on the total weight of the composition.

As well as containing the phosphines that are used, the moulding compositions according to the invention can also contain the corresponding phosphine oxides.

In principle, any desired organic UV absorbers B) can be used according to the invention. Preference is given to UV absorbers selected from the group consisting of the triazines, benzotriazoles, benzophenones, cyanoacrylates and malonic esters.

Examples of suitable UV absorbers are:

a) Benzotriazole derivatives according to formula (XI):

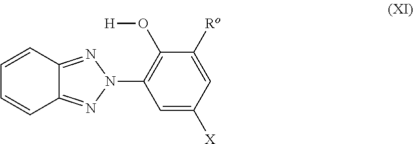

In formula (II), R° and X are identical or different and denote H or alkyl or alkylaryl.

Preference is given to Tinuvin® 329, wherein X=1,1,3,3-tetramethylbutyl and R°═H, Tinuvin® 350, wherein X=tert-butyl and R°=2-butyl, and Tinuvin® 234, wherein X and R°=1,1-dimethyl-1-phenyl.

b) Dimeric benzotriazole derivatives according to formula (XII):

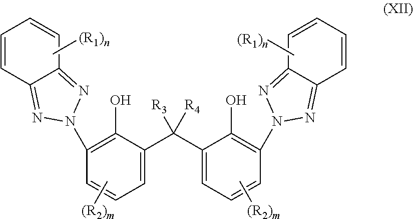

In formula (XII), R₁ and R₂ are identical or different and denote H, halogen, C₁-C₁₀-alkyl, C₅-C₁₀-cycloalkyl, C₇-C₁₃-aralkyl, C₆-C₁₄-aryl, —OR₅ or —(CO)—O—R₅, wherein R₅═H or C₁-C₄-alkyl.

In formula (XII), R₃ and R₄ are likewise identical or different and denote H, C₁-C₄-alkyl, C₅-C₆-cycloalkyl, benzyl or C₆-C₁₄-aryl.

In formula (XII), m denotes 1, 2 or 3 and n denotes 1, 2, 3 or 4.

Preference is given to Tinuvin® 360, wherein R₁═R₃═R₄═H; n=4; R₂=1,1,3,3-tetramethyl-butyl; m=1 .

b1) Dimeric benzotriazole derivatives according to formula (XIII):

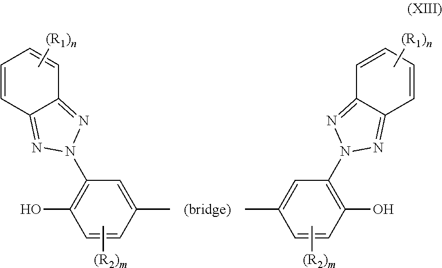

wherein the bridge denotes

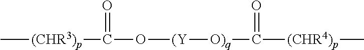

R₁, R₂, m and n have the meaning given for formula (XII), and wherein p is an integer from 0 to 3, q is an integer from 1 to 10, Y is —CH₂—CH₂—, —(CH₂)₃—, —(CH₂)₄—, —(CH₂)₅—, —(CH₂)₆— or CH(CH₃)—CH₂—, and R₃ and R₄ have the meaning given for formula (XII).

Preference is given to Tinuvin® 840, wherein R₁═H; n=4; R₂=tert-butyl; m=1; R₂ is attached in the ortho-position relative to the OH group; R₃═R₄═H; p=2; Y═—(CH₂)₅—; q=1.

c) Triazine derivatives according to formula (XIV):

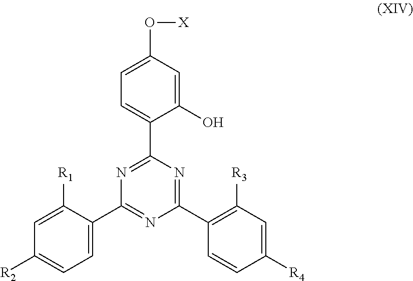

wherein R₁, R₂, R₃, R₄ are identical or different and are H, alkyl, CN or halogen, and X is alkyl.

Preference is given to Tinuvin® 1577, wherein R₁═R₂═R₃═R₄═H; X=hexyl and Cyasorb® UV-1 164, wherein R₁═R₂═R₃═R₄=methyl; X=octyl.

d) Triazine derivatives of the following formula (XIVa):

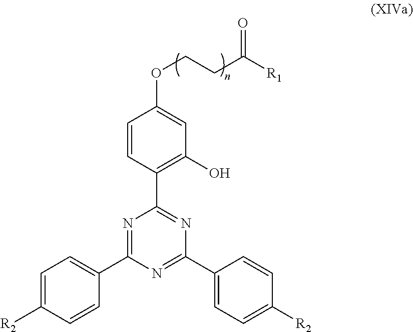

wherein R₁ denotes C₁-alkyl to C₁₇-alkyl, R₂ denotes H or C₁-alkyl to C₄-alkyl and n is from 0 to 20.

e) Dimeric triazine derivatives of formula (XV):

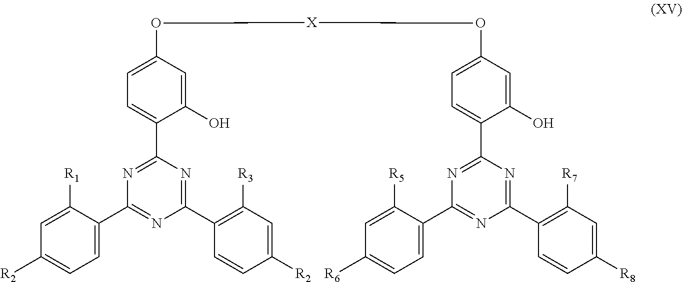

wherein R₁, R₂, R₃, R₄, R₅, R₆, R₇, R₈ can be identical or different and denote H, alkyl, CN or halogen, and X is alkylidene, preferably methylidene or —(CH₂—CH₂—O—)ₙ—C(═O)—, and n represents from 1 to 10, preferably from 1 to 5, in particular from 1 to 3.

f) Diaryl cyanoacrylates of formula (XVI):

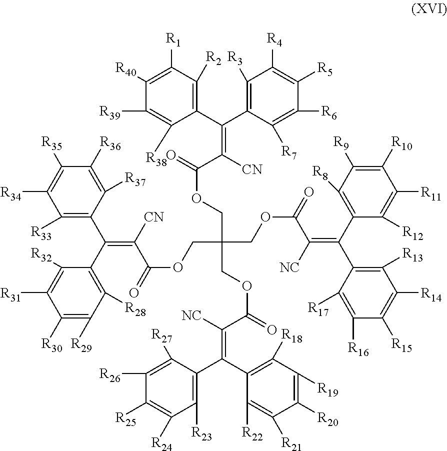

wherein R₁ to R₄₀ can be identical or different and denote H, alkyl, CN or halogen.

Preference is given to Uvinul® 3030, wherein R₁ to R₄₀═H.

g) Malonic esters of formula (XVII):

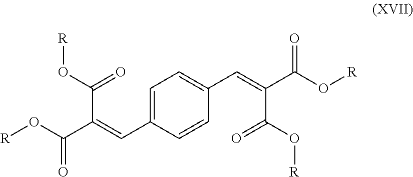

wherein R denotes alkyl. Preferably, R represents C₁-C₆-alkyl, in particular C₁-C₄-alkyl, and particularly preferably ethyl.

Particularly preferred UV stabilisers for the moulding compositions according to the invention are compounds from the group of the benzotriazoles (a), from the group of the malonic esters (g) and from the group of the cyanoacrylates (f).

The UV stabilisers are used in amounts of from 0.01 wt. % to 15 wt. %, based on the moulding composition, preferably in amounts of from 0.05 wt. % to 1 wt. %, particularly preferably in amounts of from 0.1 wt. % to 0.4 wt. %, based on the moulding composition.

The incorporation of such UV absorbers into the compositions according to the invention which are to be used is carried out by conventional methods, for example by mixing the UV absorbers in solid or liquid form directly with the melt of the moulding compositions in known mixing devices, for example extruders or kneaders, optionally additionally in combination with static mixers. Mixing can preferably also be carried out by predispersing the UV absorbers in a stream of polymer melt, for example in interconnected mixing devices comprising, for example, a lateral extruder in combination with a melt discharge device. Predispersion of the UV absorbers can, for example, also be effected by the separate preparation of a masterbatch of up to 15 wt. % UV absorber in a melt polycarbonate. Such a masterbatch can be added to the melt of the moulding compositions either directly or via a mixing device.

The polycarbonate to be used according to the invention is prepared by the melt transesterification reaction of suitable bisphenols and carbonic acid diaryl esters in the presence of a suitable catalyst. The polycarbonate can also be prepared by the condensation of carbonate oligomers containing hydroxy and/or carbonate end groups, and suitable carbonic acid diaryl esters and bisphenols. The polycarbonate to be used according to the invention can also be prepared according to a two-stage process by the preparation of carbonate oligomers in the above-mentioned melt transesterification reaction and the subsequent polycondensation of the carbonate oligomers in solid finely divided phase at elevated temperature in vacuo or while passing through hot inert gases.

Preferred carbonate oligomers are described by formula (IV), having molecular weights of from 153 to 15,000 [g/mol].

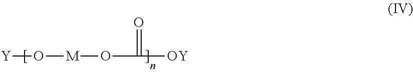

wherein Y is H or an unsubstituted or substituted aryl radical, and n and M have the corresponding meanings given in the description on p. 16 and 17.

Suitable carbonic acid diaryl esters in connection with the invention are di-C₆- to di-C₁₄-aryl esters, preferably the diesters of phenol or of alkyl- or aryl-substituted phenols, i.e. diphenyl carbonate, dicresyl carbonate and di-4-tert-butylphenyl carbonate. Diphenyl carbonate is most preferred.

Suitable di-C₆- to di-C₁₄-aryl esters also include asymmetrical diaryl esters, which contain two different aryl substituents. Phenylcresyl carbonate and 4-tert-butylphenyl phenyl carbonate are preferred.

Suitable diaryl esters also include mixtures of more than one di-C₆-C₁₄-aryl ester. Preferred mixtures are mixtures of diphenyl carbonate, dicresyl carbonate and di-4-tert-butylphenyl carbonate.

Based on 1 mol of diphenol, the carbonic acid diaryl esters can be used in amounts of from 1.00 to 1.30 mol, particularly preferably in amounts of from 1.02 to 1.20 mol and most preferably in amounts of from 1.05 to 1.15 mol.

Suitable dihydroxyaryl compounds in connection with the invention are those which correspond to formula (V):

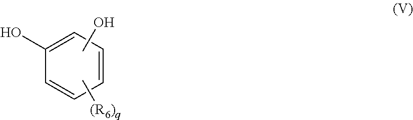

wherein
R₆ is a substituted or unsubstituted phenyl, methyl, propyl, ethyl, butyl, Cl or Br, and q represents 0, 1 or 2.

Preferred dihydroxybenzene compounds are 1,3-dihydroxybenzene, 1,4-dihydroxybenzene and 1,2-dihydroxybenzene.

Suitable dihydroxydiaryl compounds in connection with the invention are those which correspond to formula (VI):

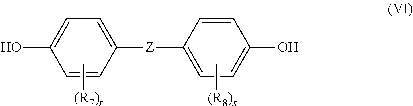

wherein
Z is C₁- to C₈-alkylidene or C₅- to C₁₂-cycloalkylidene, S, SO₂ or a single bond,
R₇, R₈ independently of one another are a substituted or unsubstituted phenyl, methyl, propyl, ethyl, butyl, Cl or Br, and
r, s independently of one another represent 0, 1 or 2.

Preferred diphenols are 4,4′-dihydroxydiphenyl, 4,4′-dihydroxydiphenyl sulfide, 1,1-bis(4-hydroxphenyl)cyclohexane, 1,2-bis(4-hydroxyphenyl)benzene, 1,3-bis(4-hydroxyphenyl)benzene, 1,4-bis(4-hydroxyphenyl)benzene, bis(4-hydroxyphenyl)methane, 2,2-bis(4-hydroxyphenyl)-propane, 2,4-bis(4-hydroxyphenyl)-2-methylbutane, 2,2-bis(3-methyl-4-hydroxy-phenyl)-propane, 2,2-bis(3-chloro-4-hydroxyphenyl)propane, bis(3,5-dimethyl-4-hydroxy-phenyl)methane, 2,2-bis-(3,5-dimethyl-4-hydroxyphenyl)propane, bis(3,5-dimethyl-4-hydroxyphenyl)sulfone, bis(4-hydroxyphenyl)sulfone, 1,2-bis [2-(4-hydroxyphenyl)isopropyl]benzene, 1,3-bis[2-(4-hydroxy-phenyl)isopropyl]benzene, 1,4-bis[2-(4-hydroxyphenyl)isopropyl]benzene, 1,1-bis(4-hydroxy-phenyl)-1-phenylethane, 2,4-bis(4-hydroxyphenyl)-2-methylbutane, 2,2-bis-(3,5-dichloro-4-hydroxyphenyl)-propane, 2,2-bis(3,5-dibromo-4-hydroxyphenyl)propane, 1,1-bis(4-hydroxy-phenyl)-3,3,5-trimethylcyclohexane.

The diphenols that are most preferred are 1,1-bis(4-hydroxyphenyl)-1-phenylethane, 2,2-bis(4-hydroxyphenyl)propane, 4,4′-dihydroxydiphenyl, 1,1-bis(4-hydroxyphenyl)-3,3,5-trimethylcyclo-hexane, 2,2-bis(3,5-dibromo-4-hydroxyphenyl)propane and 1,3-bis[2-(4-hydroxyphenyl)-isopropyl]benzene.

Suitable diphenols also include mixtures of more than one diphenol; a copolycarbonate would thereby be formed. The mixing partners that are most preferred are 1,3-bis[2-(4-hydroxy-phenyl)isopropyl]benzene, 1,1-bis(4-hydroxyphenyl)-3,3,5-trimethylcyclohexane, 2,2-bis(4-hydroxyphenyl)propane, 4,4′-dihydroxydiphenyl and 2,2-bis(3,5-dibromo-4-hydroxy-phenyl)propane.

In addition, a branching agent can be added, for example compounds containing three functional phenolic OH groups. The non-Newtonian flow behaviour would be increased by the branching. Suitable branching agents include phloroglucinol, 3,3-bis(3-methyl-4-hydroxyphenyl)-2-oxo-2,3-dihydroindole, 4,6-dimethyl-2,4,6-tris(4-hydroxyphenyl)hept-2-ene, 4,6-dimethyl-2,4,6-tris(4-hydroxyphenyl)-heptane, 1,3,5-tris-(4-hydroxyphenyl)benzene, 1,1,1-tris(4-hydroxyphenyl)ethane, tris(4-hydroxyphenyl)phenylmethane, 2,2-bis[4,4-bis(4-hydroxyphenyl)cyclohexyl]propane, 2,4-bis-(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, hexakis(4-(4-hydroxyphenylisopropyl)phenyl)orthoterephthalate, tetrakis(4-hydroxyphenyl)methane, tetrakis(4-(4-hydroxyphenylisopropyl)-phenoxy)methane, 1,4-bis((4′,4″-dihydroxytriphenyl)methyl)benzene and isatinbiscresol, pentaerythritol, 2,4-dihydroxybenzoic acid, trimesic acid, cyanuric acid.

Catalysts suitable for the preparation of the polycarbonates according to the invention are, for example, those of the general formula (VII)

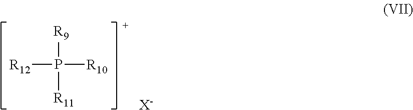

wherein

R₉, R₁₀, R₁₁ and R₁₂ independently of one another can denote identical or different C₁- to C₁₈-alkylenes, C₆- to C₁₀-aryls or C₅- to C₆-cycloalkyls, and X⁻ can represent an anion, in which the corresponding acid-base pair H⁺+X⁻→HX has a pK_{b} of <11.

Preferred catalysts are tetraphenylphosphonium fluoride, tetraphenylphosphonium tetraphenyl-borate and tetraphenylphosphonium phenolate. Tetraphenylphosphonium phenolate is most preferred. Preferred amounts of phosphonium salt catalysts are, for example, from 10⁻² to 10⁻⁸ mol per mol of diphenol, and the catalyst amounts that are most preferred are from 10⁻⁴ to 10⁻⁶ mol per mol of diphenol. It is also possible to use cocatalysts in addition to the phosphonium salt(s), in order to increase the rate of polymerisation.

Such cocatalysts can be, for example, salts of alkali metals and alkaline earth metals, such as hydroxides, alkoxides and aryl oxides of lithium, sodium and potassium, preferably hydroxide, alkoxide or aryl oxide salts of sodium. Sodium hydroxide and sodium phenolate are most preferred. The amounts of cocatalyst can be, for example, in the range from 1 to 200 μg/kg, preferably from 5 to 150 μg/kg and most preferably from 10 to 125 μg/kg, in each case based on the mass of dihydroxydiaryl compound used, in each case calculated as sodium.

The polycarbonates can be prepared stepwise, the temperatures can be carried out stepwise in the range from 150 to 400° C., the dwell time in each stage can be from 15 minutes to 5 hours, and the pressures in each stage can be from 1000 to 0.01 mbar. Particularly preferably, the temperature increases from one stage to another and the pressure falls from one stage to the next.

The melt polycarbonates that are preferably used are characterised by the general formula (IV)

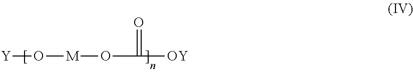

wherein the square brackets denote n structural repeating units, M represents Ar or a multifunctional compound A, B, C and compound D, wherein Ar can be a compound that is represented by formula (VIII) or (IX), preferably (IX)

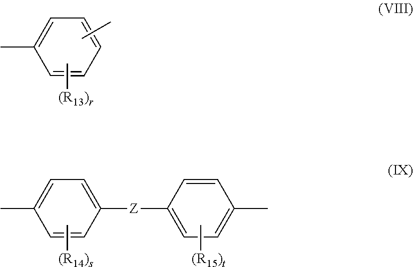

wherein
Z is C₁- to C₈-alkylidene or C₅- to C₁₂-cycloalkylidene, S, SO₂ or a single bond,
R₁₃, R₁₄, R₁₅ independently of one another are a substituted or unsubstituted C₁-C₁₈-alkyl radical, preferably a substituted or unsubstituted phenyl, methyl, propyl, ethyl, butyl, Cl or Br, and
r, s, t independently of one another represent 0, 1 or 2,
n is a natural number,

wherein the multifunctional compound A is a compound of the formula

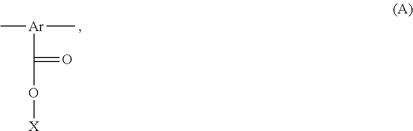

wherein the multifunctional compound B is a compound of the formula

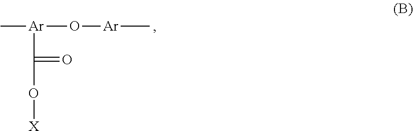

wherein the multifunctional compound C is a compound of the formula

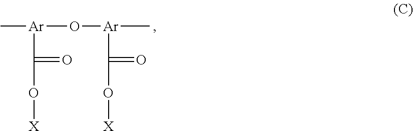

wherein compound D is a compound of the formula

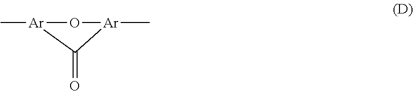

and the sum of multifunctional compounds A, B, C and D is ≧5 mg/kg,

wherein Y is H or a compound of formula (X)

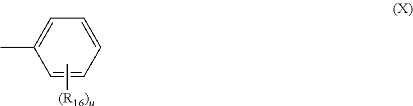

wherein

the radicals R₁₆, which are identical or different, can be H, C₁- to C₂₀-alkyl, C₆H₅ or C(CH₃)₂C₆H₅, and
u can be 0, 1, 2 or 3,

wherein X is Y or -[MOCOO]ₙ—Y, wherein M and Y have the meaning given above.

The polycarbonate used according to the invention can have a mean molecular weight, determined by gel permeation chromatography, of from 5000 to 80,000, preferably from 10,000 to 60,000 and most preferably from 15,000 to 40,000.

Ar preferably has the following meaning:

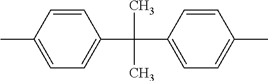

The multifunctional compound A is preferably the compound A1:

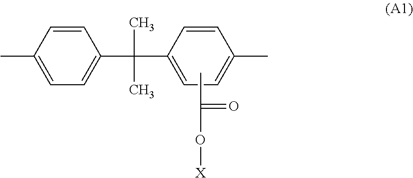

Compound B is preferably the compound B1:

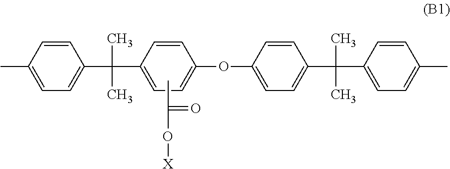

The multifunctional compound C is preferably the compound C1:

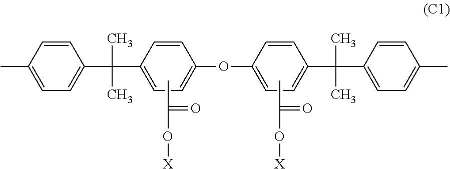

In compounds A1, B1 and C1, X has the meaning given above. Compound D is preferably the compound D1:

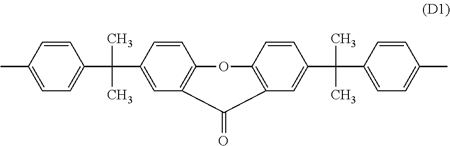

The melt polycarbonates described above have been mentioned only by way of example. Components A to D are present in the melt polycarbonate in total amounts of ≧5 mg/kg.

Alkyl phosphates C) which are optionally used according to the invention are compounds of the general formula (II):

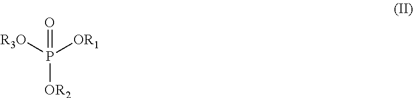

wherein R₁ to R₃ can be H, identical or different linear, branched or cyclic alkyl radicals. C₁-C₁₈-Alkyl radicals are particularly preferred. C₁-C₁₈-Alkyl represents, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, n-heptyl and n-octyl, pinacyl, adamantyl, the isomeric menthyls, n-nonyl, n-decyl, n-dodecyl, n-tridecyl, n-tetradecyl, n-hexadecyl or n-octadecyl.

Alkyl phosphates which are suitable according to the invention are, for example, mono-, di- and tri-hexyl phosphate, triisooctyl phosphate and trinonyl phosphate. Triisooctyl phosphate (tris-2-ethyl-hexyl phosphate) is preferably used as the alkyl phosphate. It is also possible to use mixtures of different mono-, di- and tri-alkyl phosphates.

The alkyl phosphates that are used are employed in amounts of from 0 to 500 mg/kg, preferably from 0.5 to 500 mg/kg, particularly preferably from 2 to 500 mg/kg, based on the total weight of the composition.

Aliphatic carboxylic acid esters D) which are optionally used according to the invention are esters of aliphatic long-chain carboxylic acids with mono- or poly-valent aliphatic and/or aromatic hydroxy compounds. Aliphatic carboxylic acid esters that are particularly preferably used are compounds of the general formula (III):

(R₄—CO—O)ₒ—R₅—(OH)ₚ wherein o=from 1 to 4 and p=from 3 to 0 (III)

wherein R₄ is an aliphatic saturated or unsaturated, linear, cyclic or branched alkyl radical and R₅ is an alkylene radical of a mono- to tetra-hydric aliphatic alcohol R₅—(OH)ₒ₊ₚ.

C₁-C₁₈-Alkyl radicals are particularly preferred for R₄. C₁-C₁₈-Alkyl represents, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-di-methylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, n-heptyl and n-octyl, pinacyl, adamantyl, the isomeric menthyls, n-nonyl, n-decyl, n-dodecyl, n-tridecyl, n-tetradecyl, n-hexadecyl or n-octadecyl.

Alkylene represents a straight-chain, cyclic, branched or unbranched C₁-C₁₈-alkylene radical. C₁-C₁₈-alkylene represents, for example, methylene, ethylene, n-propylene, isopropylene, n-butylene, n-pentylene, n-hexylene, n-heptylene, n-octylene, n-nonylene, n-decylene, n-dodecylene, n-tridecylene, n-tetradecylene, n-hexadecylene or n-octadecylene.

In the case of esters of polyhydric alcohols, free, non-esterified OH groups can also be present. Aliphatic carboxylic acid esters that are suitable according to the invention are, for example: glycerol monostearate, palmityl palmitate and stearyl stearate. It is also possible to use mixtures of different carboxylic acid esters of formula (III). Carboxylic acid esters that are preferably used are esters of pentaerythritol, glycerol, trimethylolpropane, propanediol, stearyl alcohol, cetyl alcohol or myristyl alcohol with myristic, palmitic, stearic or montanic acid, and mixtures thereof. Pentaerythritol tetrastearate, glycerol monostearate, stearyl stearate and propanediol stearate, and mixtures thereof, are particularly preferred.

The carboxylic acid esters are used in amounts of from 0 to 12,000 mg/kg, preferably from 500 to 10,000 mg/kg, particularly preferably from 2000 to 8000 mg/kg, based on the total weight of the composition.

The compositions according to the invention (melt polycarbonate moulding compositions) can be prepared, for example, by mixing the constituents in known manner and melt compounding or melt extruding the mixture at temperatures of from 200° C. to 400° C. in conventional devices such as internal kneaders, extruders and twin-shaft screws. Mixing of the individual constituents can take place either in succession or simultaneously, either at about 20° C. (room temperature) or at a higher temperature. The compounds used according to the invention can, however, also be introduced into the melt polycarbonate moulding composition separately at different stages of the preparation process. For example, the alkyl phosphate and/or the triarylphosphine can be introduced into the melt polycarbonate during or at the end of the polycondensation, before aliphatic carboxylic acid esters are added.

There are no limits regarding the manner in which the compounds according to the invention are added. The compounds according to the invention, or the mixtures of the compounds according to the invention, can be added to the polymer melt in the form of solids, e.g. in powder form, in solution or in the form of a melt. The metered addition of the organic phosphorus compounds and of the aliphatic carboxylic acid esters preferably takes place via a lateral extruder downstream of the last polycondensation stage. In industrial embodiments, a lateral extruder is particularly preferably operated with a throughput of, for example, from 200 to 1000 kg of polycarbonate per hour.

The addition of the UV absorbers preferably takes place in liquid form at a temperature of approximately from 80 to 250° C. downstream of the polycarbonate feed funnel, into a zone of the lateral extruder that is equipped with mixing elements. The UV absorbers are thereby removed from a loop which is preferably maintained at a pressure of from 2 to 20 bar, preferably at a temperature of from 80 to 250° C. The amount added can be controlled via a control valve. In another preferred embodiment, the UV absorbers are added in solid form to the polycarbonate feed funnel of the lateral extruder.

In a preferred embodiment, the optional metered addition of alkyl phosphates is carried out, for example, at room temperature in liquid form, together with polycarbonate, into the polycarbonate feed funnel of the lateral extruder. The amount of alkyl phosphate is metered, for example, with the aid of a diaphragm pump or another suitable pump. Triarylphosphines are preferably added in liquid form at a temperature of approximately from 80 to 250° C. downstream of the polycarbonate feed funnel, into a zone of the lateral extruder that is equipped with mixing elements. The phosphines are thereby removed from a loop which is preferably maintained at a pressure of from 2 to 20 bar, preferably at a temperature of from 80 to 250° C. The amount added can be controlled via a control valve.

Particularly preferably, a gear pump can be installed downstream of the lateral extruder for increasing the pressure. The carboxylic acid esters that are used can preferably be metered in downstream of the lateral extruder and upstream of the static mixer, by means of a diaphragm pump or another suitable pump. The carboxylic acid esters are then preferably metered in liquid form downstream of the gear pump, particularly preferably at from 80 to 250° C., by means of a diaphragm pump, at elevated pressure, particularly preferably from 50 to 250 bar. Alternatively, it is also possible for the carboxylic acid esters to be introduced into the melt stream in the mixing zone of the lateral extruder, via a control valve.

In a particularly preferred embodiment, a static mixer is located downstream of the lateral extruder and all the additive metering sites, in order to ensure that all the additives are mixed thoroughly. The polycarbonate melt of the lateral extruder is then introduced into the main polycarbonate melt stream. Mixing of the main melt stream with the melt stream of the lateral extruder takes place via a further static mixer.

As an alternative to metering in liquid form, the phosphines and the carboxylic acid esters can be metered in the form of a masterbatch (concentrate of the additives in polycarbonate) or in pure, solid form, via the polycarbonate feed funnel of the lateral extruder. Such a masterbatch can contain further additives.

All additives can also be introduced into the polycarbonate subsequently, for example by compounding.

The moulding compositions according to the invention can be used in the production of moulded bodies of any type.

These can be produced preferably by injection moulding but also, in a corresponding modification, by extrusion and blow moulding processes. A further form of processing is the production of moulded bodies by deep drawing from previously produced sheets or films.

Examples of moulded bodies according to the invention are profiles, films, casing parts of any kind, e.g. for domestic appliances such as juice extractors, coffee machines, mixers; for office equipment such as monitors, printers, copiers; for sheets and coextruded layers thereof, pipes, electrical installation conduits, windows, doors and profiles for the construction sector, interior fittings and external applications; in the electrical engineering field, e.g. for switches and sockets. The moulded bodies according to the invention can also be used for interior fittings and components for railway vehicles, ships, aircraft, buses and other motor vehicles, as well as for automotive bodywork parts.

The moulded bodies according to the invention can be transparent, translucent or opaque. Further moulded bodies are in particular optical and magneto-optical data storage media, such as mini disks, compact disks (CDs) or digital versatile disks (DVDs), food and drinks packaging, optical lenses and prisms, lenses for lighting purposes, automotive headlight lenses, glazing for construction and motor vehicles, other types of glazing, such as for greenhouses, so-called double-skin sheets or twin-wall sheets.

### EXAMPLES

The compounds according to the invention were produced on a ZE25/3 extruder from Berstorff, Hanover, with a throughput of 10 kg/hour. The case temperatures were from 220 to 260° C. The various additives were metered in the form of a powder mixture with polycarbonate powder—5 wt. %, based on the total weighed amount.

Raw Materials Used:

PC 1 is a polycarbonate without additives based on bisphenol A and DPC (diphenyl carbonate), having a melt volume-flow rate (MVR) of 11.4 cm³/10 min (300° C./1.2 kg). Multifunctional compounds A: 370 ppm, B: 11 ppm, C: 35 ppm, D: 67 ppm. Phenolic OH groups: 297 mg/kg.

PC 2 is a polycarbonate without additives based on bisphenol A, having an MVR of 19 cm³/10 min (300° C./1.2 kg). Multifunctional compounds A, B, C and D below the detection limit.
TPP: triphenylphosphine
PETS: pentaerythritol tetrastearate
Loxiol G32: stearyl stearate
GMS: glycerol monostearate
Trialkyl phosphite: tris[(3-ethyl-3-oxetanyl)methyl]phosphite
Tinuvin 329: 2-(2-hydroxy-5-t-octylphenyl)benzotriazole
Hostavin B-cap: p-phenylene-bis(methylenemalonic acid)tetraethyl ester
Uvinul 3030: 1,3-bis[(2-cyano-3,3-diphenylacryloyl)oxy]-2,2-bis[[(2-cyano-3,3-diphenylacryloyl)oxy]methyl]propane

Characterisation of the Moulding Compositions According to the Invention (Test Methods):

Melt viscosity: The rheological properties are determined by measuring the melt viscosity of the moulding compositions according to the invention in Pa·s at temperatures of from 280° C. to 300° C. in dependence on the shear gradient (eta), which can vary between 50 and 5000 [l/s]. The measurement is carried out in accordance with ISO 11443 with the aid of a capillary rheometer.

Colour measurement on moulded bodies by determination of the yellowness index YI: The optical properties of the moulding compositions according to the invention are determined by measuring the so-called yellowness index (YI) on standard test specimens in accordance with ASTM E313.

Determination of the relative viscosity (Eta-rel): The relative solution viscosity eta rel is determined in methylene chloride (0.5 g of polycarbonate/l) at 25° C. in an Ubbelohde viscometer.

Determination of the hydrolytic stability by means of a boiling test: The hydrolytic stability of the moulding compositions according to the invention is determined by means of a so-called boiling test in water, wherein standard test specimens are stored for a period of 100 hours in pure water under reflux at normal pressure. Changes in the moulded bodies so stored are determined by measuring the relative solution viscosity. The ΔEta rel. value after 50 and 100 hours is the change in the Eta rel. value as compared with the initial value. A negative sign means a fall in the Eta rel. value after the boiling test, and therefore degradation of the polymer. If the Eta rel. value falls by more than 0.023 after 50 hours or more than 0.025 after 100 hours, the boiling test is not passed.

The melt volume-flow rate (MVR) is determined at 300° C. and under a 1.2 kg load using a melt index tester in accordance with ISO 1133.

Tables 1 to 4 show the composition of the compounds prepared and the melt viscosities, the YI values of 4 mm sheets and the relative viscosity before, after a 50-hour boiling test and after a 100-hour boiling test as a measure of the hydrolytic stability of the moulding compositions according to the invention.

Examples according to the invention are nos.: 2, 5, 8, 9, 12, 13, 16, 17, 20, 21, 24, 25, 27, 28 and 29.

Example no. 1 is the reference example without additives.

Examples 3, 4, 6, 7, 10, 11, 14, 15, 18, 19, 22, 23 and 26 are also not according to the invention.

As compared with the Reference Example 1, all the examples according to the invention exhibit improved flowability, determined by means of the measured melt viscosities, and improved optical properties, shown by the lower YI value. All the examples according to the invention additionally exhibit good hydrolytic stability, which is demonstrated by a very small change in the relative viscosity after the boiling test.

In contrast to the examples according to the invention, Examples 3, 4, 6, 7, 10, 11, 14, 15, 18, 19, 23 and 26, which are not according to the invention, exhibit a poorer YI value as compared with Reference Example 1 without additives.

Examples 3, 6, 11, 14, 15, 18, 19, 22 and 26, which are not according to the invention, additionally exhibit poor hydrolytic stability, which is shown by the significant fall in the relative viscosity after the boiling test. The ΔEta rel. value, as compared with the initial value for this sample, is markedly more than −0.023 after a 50-hour boiling test and markedly more than −0.025 after 100 hours. For all the examples according to the invention, the ΔEta rel. value, as compared with the initial value, is markedly less than −0.023 after a 50-hour boiling test and markedly less than −0.025 after 100 hours.

The data in Tables 1 to 4 demonstrate that the combination according to the invention of the three features: good hydrolytic stability, improved flowability and improved optical properties, is achieved only by the compositions according to the invention.

TABLE 1
Examples 1-14, melt viscosities of prepared compounds

| Example No.: | | 1 | 2 | 3 | 4 | 5 | 6 | 7 |
|---|---|---|---|---|---|---|---|---|
| Formulation acc. to inv.? | | no | yes | no | no | yes | no | no |
| PC1 | % | 95 | 95 | 95 | 95 | 95 | 95 | 95 |
| PC2 | % | 5.00 | 4.70 | 4.70 | 4.75 | 4.30 | 4.30 | 4.35 |
| PETS | % | — | — | — | — | 0.40 | 0.40 | 0.40 |
| TPP | % | — | 0.05 | — | — | 0.05 | — | — |
| Trialkyl phosphite | % | — | — | 0.05 | — | — | 0.05 | — |
| Tinuvin 329 | % | — | 0.25 | 0.25 | 0.25 | 0.25 | 0.25 | 0.25 |
| Hostavin B-Cap | % | | | | | | | |
| Uvinul 3030 | % | | | | | | | |
| GMS | % | | | | | | | |
| Loxiol G32 | % | | | | | | | |
| Melt viscosity, 280° C. | | | | | | | | |
| eta 200 [1/s] | Pas | 703 | 639 | 640 | 649 | 554 | 598 | 556 |
| eta 500 [1/s] | Pas | 562 | 497 | 523 | 531 | 460 | 492 | 456 |
| eta 1000 [1/s] | Pas | 428 | 369 | 403 | 407 | 366 | 386 | 359 |
| eta 1500 [1/s] | Pas | 348 | 320 | 328 | 330 | 304 | 318 | 297 |
| Melt viscosity, 300° C. | | | | | | | | |
| eta 200 [1/s] | Pas | 362 | 325 | 317 | 289 | 206 | 333 | 245 |
| eta 500 [1/s] | Pas | 317 | 283 | 284 | 266 | 186 | 297 | 224 |
| eta 1000 [1/s] | Pas | 266 | 241 | 242 | 220 | 169 | 253 | 192 |
| eta 1500 [1/s] | Pas | 230 | 211 | 211 | 195 | 151 | 220 | 174 |

| Example No.: | 8 | 9 | 10 | 11 | 12 | 13 | 14 |
|---|---|---|---|---|---|---|---|
| Formulation acc. to inv.? | yes | yes | no | no | yes | yes | no |
| PC1 | 95 | 95 | 95 | 95 | 95 | 95 | 95 |
| PC2 | 4.740 | 4.725 | 4.740 | 4.725 | 4.340 | 4.325 | 4.340 |
| PETS | — | — | — | — | 0.40 | 0.40 | 0.40 |
| TPP | 0.010 | 0.025 | — | — | 0.010 | 0.025 | — |
| Trialkyl phosphite | — | — | 0.010 | 0.025 | — | — | 0.010 |
| Tinuvin 329 | 0.25 | 0.25 | 0.25 | 0.25 | 0.25 | 0.25 | 0.25 |
| Hostavin B-Cap | | | | | | | |
| Uvinul 3030 | | | | | | | |
| GMS | | | | | | | |
| Loxiol G32 | | | | | | | |
| Melt viscosity, 280° C. | | | | | | | |
| eta 200 [1/s] | 669 | 641 | 651 | 634 | 645 | 618 | 648 |
| eta 500 [1/s] | 541 | 485 | 526 | 522 | 521 | 500 | 521 |
| eta 1000 [1/s] | 415 | 386 | 405 | 403 | 403 | 385 | 398 |
| eta 1500 [1/s] | 337 | 324 | 328 | 329 | 328 | 310 | 323 |
| Melt viscosity, 300° C. | | | | | | | |
| eta 200 [1/s] | 302 | 332 | 334 | 346 | 335 | 324 | 339 |
| eta 500 [1/s] | 274 | 294 | 300 | 306 | 299 | 292 | 300 |
| eta 1000 [1/s] | 233 | 250 | 257 | 259 | 254 | 247 | 254 |
| eta 1500 [1/s] | 205 | 217 | 222 | 225 | 220 | 214 | 220 |

TABLE 2
Examples 15-28, melt viscosities of prepared compounds

| Example No.: | | 15 | 16 | 17 | 18 | 19 | 20 | 21 | 22 |
|---|---|---|---|---|---|---|---|---|---|
| Formulation acc. to inv.? | | no | yes | yes | no | no | yes | yes | no |
| PC1 | % | 95 | 95 | 95 | 95 | 95 | 95 | 95 | 95 |
| PC2 | % | 4.32 | 4.52 | 3.92 | 4.52 | 3.92 | 4.87 | 4.57 | 4.87 |
| PETS | % | 0.40 | 0.20 | 0.80 | 0.20 | 0.80 | | — | |
| TPP | % | | 0.02 | 0.02 | | | 0.02 | 0.02 | |
| Trialkyl phosphite | % | 0.02 | | | 0.02 | 0.02 | | — | 0.02 |
| Tinuvin 329 | % | 0.25 | 0.25 | 0.25 | 0.25 | 0.25 | 0.1 | 0.4 | 0.1 |
| Hostavin B-Cap | % | | | | | | | | |
| Uvinul 3030 | % | | | | | | | | |
| GMS | % | | | | | | | | |
| Loxiol G32 | % | | | | | | | | |
| Melt viscosity, 280° C. | | | | | | | | | |
| eta 200 [1/s] | Pas | 626 | 641 | 597 | 616 | 575 | 670 | 649 | 627 |
| eta 500 [1/s] | Pas | 508 | 523 | 483 | 508 | 483 | 545 | 527 | 524 |
| eta 1000 [1/s] | Pas | 391 | 397 | 374 | 393 | 375 | 418 | 407 | 405 |
| eta 1500 [1/s] | Pas | 319 | 324 | 300 | 320 | 309 | 338 | 329 | 329 |
| Melt viscosity, 300° C. | | | | | | | | | |
| eta 200 [1/s] | Pas | 339 | 328 | 293 | 330 | 295 | 345 | 302 | 324 |
| eta 500 [1/s] | Pas | 295 | 292 | 264 | 292 | 268 | 307 | 179 | 292 |
| eta 1000 [1/s] | Pas | 250 | 243 | 225 | 246 | 229 | 245 | 239 | 249 |
| eta 1500 [1/s] | Pas | 216 | 211 | 196 | 213 | 201 | 215 | 211 | 216 |

| Example No.: | 23 | 24 | 25 | 26 | 27 | 28 | 29 |
|---|---|---|---|---|---|---|---|
| Formulation acc. to inv.? | no | yes | yes | no | yes | yes | yes |
| PC1 | 95 | 95 | 95 | 95 | 95 | 95 | 95 |
| PC2 | 4.57 | 4.47 | 4.17 | 4.17 | 4.32 | 4.32 | 4.32 |
| PETS | | 0.40 | 0.40 | 0.40 | | | |
| TPP | | 0.02 | 0.02 | | 0.02 | 0.02 | 0.02 |
| Trialkyl phosphite | 0.02 | | | 0.02 | | | |
| Tinuvin 329 | 0.4 | 0.1 | 0.4 | 0.4 | | | |
| Hostavin B-Cap | | | | | 0.25 | 0.25 | |
| Uvinul 3030 | | | | | | | 0.25 |
| GMS | | | | | 0.4 | | 0.4 |
| Loxiol G32 | | | | | | 0.4 | |
| Melt viscosity, 280° C. | | | | | | | |
| eta 200 [1/s] | 590 | 644 | 624 | 561 | 367 | 622 | 353 |
| eta 500 [1/s] | 494 | 523 | 504 | 463 | 311 | 509 | 293 |
| eta 1000 [1/s] | 396 | 403 | 390 | 368 | 250 | 394 | 247 |
| eta 1500 [1/s] | 328 | 329 | 319 | 305 | 217 | 321 | 225 |
| Melt viscosity, 300° C. | | | | | | | |
| eta 200 [1/s] | 338 | 279 | 320 | 328 | 168 | 313 | 155 |
| eta 500 [1/s] | 302 | 253 | 285 | 284 | 156 | 276 | 152 |
| eta 1000 [1/s] | 260 | 233 | 240 | 223 | 141 | 233 | 134 |
| eta 1500 [1/s] | 227 | 209 | 209 | 195 | 130 | 202 | 120 |

TABLE 3
Examples 1-14, YI on 4 mm sheets and relative viscosities of prepared
compounds before and after 50-hour and 100-hour boiling test

| Example No.: | | 1 | 2 | 3 | 4 | 5 | 6 | 7 |
|---|---|---|---|---|---|---|---|---|
| Formulation acc. to inv.? | | no | yes | no | no | yes | no | no |
| PC1 | % | 95 | 95 | 95 | 95 | 95 | 95 | 95 |
| PC2 | % | 5.00 | 4.70 | 4.70 | 4.75 | 4.30 | 4.30 | 4.35 |
| PETS | % | — | — | — | — | 0.40 | 0.40 | 0.40 |
| TPP | % | — | 0.05 | — | — | 0.05 | — | — |
| Trialkyl phosphite | % | — | — | 0.05 | — | — | 0.05 | — |
| Tinuvin 329 | % | — | 0.25 | 0.25 | 0.25 | 0.25 | 0.25 | 0.25 |
| Hostavin B-Cap | % | | | | | | | |
| Uvinul 3030 | % | | | | | | | |
| GMS | % | | | | | | | |
| Loxiol G32 | % | | | | | | | |
| opt. data in 4 mm | | | | | | | | |
| Y.I. | | 2.81 | 2.00 | 3.39 | 3.23 | 2.15 | 2.99 | 3.52 |
| Rel. viscosity (Eta rel.) | | | | | | | | |
| O h, granules | | 1.27 | 1.276 | 1.273 | 1.274 | 1.277 | 1.272 | 1.272 |
| After 50 h boiling test | | 1.27 | 1.272 | 1.220 | 1.272 | 1.271 | 1.207 | 1.270 |
| After 100 h boiling test | | 1.27 | 1.272 | 1.185 | 1.270 | 1.266 | 1.168 | 1.264 |
| Δ Eta rel. after 50 h | | — | −0.004 | −0.053 | −0.002 | −0.006 | −0.065 | −0.002 |
| Δ Eta rel. after 100 h | | — | −0.004 | −0.088 | −0.004 | −0.011 | −0.104 | −0.008 |

| Example No.: | 8 | 9 | 10 | 11 | 12 | 13 | 14 |
|---|---|---|---|---|---|---|---|
| Formulation acc. to inv.? | yes | yes | no | no | yes | yes | no |
| PC1 | 95 | 95 | 95 | 95 | 95 | 95 | 95 |
| PC2 | 4.740 | 4.725 | 4.740 | 4.725 | 4.340 | 4.325 | 4.340 |
| PETS | — | — | — | — | 0.40 | 0.40 | 0.40 |
| TPP | 0.010 | 0.025 | — | — | 0.010 | 0.025 | — |
| Trialkyl phosphite | — | — | 0.010 | 0.025 | — | — | 0.010 |
| Tinuvin 329 | 0.25 | 0.25 | 0.25 | 0.25 | 0.25 | 0.25 | 0.25 |
| Hostavin B-Cap | | | | | | | |
| Uvinul 3030 | | | | | | | |
| GMS | | | | | | | |
| Loxiol G32 | | | | | | | |
| opt. data in 4 mm | | | | | | | |
| Y.I. | 2.68 | 2.47 | 3.45 | 3.50 | 2.63 | 2.25 | 3.16 |
| Rel. viscosity (Eta rel.) | | | | | | | |
| O h, granules | 1.276 | 1.276 | 1.276 | 1.276 | 1.275 | 1.275 | 1.276 |
| After 50 h boiling test | 1.273 | 1.271 | 1.273 | 1.234 | 1.278 | 1.269 | 1.252 |
| After 100 h boiling test | 1.271 | 1.271 | 1.269 | 1.206 | 1.269 | 1.269 | 1.242 |
| Δ Eta rel. after 50 h | −0.003 | −0.005 | −0.003 | −0.042 | 0.003 | −0.006 | −0.024 |
| Δ Eta rel. after 100 h | −0.005 | −0.005 | −0.007 | −0.07 | −0.006 | −0.006 | −0.034 |

TABLE 4
Examples 15-28, YI on 4 mm sheets and relative viscosities of prepared
compounds before and after 50-hour and 100-hour boiling test

| Example No.: | | 15 | 16 | 17 | 18 | 19 | 20 | 21 | 22 |
|---|---|---|---|---|---|---|---|---|---|
| Formulation acc. to inv.? | | no | yes | yes | no | no | yes | yes | no |
| PC1 | % | 95 | 95 | 95 | 95 | 95 | 95 | 95 | 95 |
| PC2 | % | 4.32 | 4.525 | 3.925 | 4.525 | 3.925 | 4.875 | 4.57 | 4.875 |
| PETS | % | 0.40 | 0.20 | 0.80 | 0.20 | 0.80 | | — | |
| TPP | % | | 0.025 | 0.025 | | | 0.025 | 0.02 | |
| Trialkyl phosphite | % | 0.02 | | | 0.025 | 0.025 | | — | 0.025 |
| Tinuvin 329 | % | 0.25 | 0.25 | 0.25 | 0.25 | 0.25 | 0.1 | 0.4 | 0.1 |
| Hostavin B-Cap | % | | | | | | | | |
| Uvinul 3030 | % | | | | | | | | |
| GMS | % | | | | | | | | |
| Loxiol G32 | % | | | | | | | | |
| opt. data in 4 mm | | | | | | | | | |
| Y.I. | | 2.94 | 2.36 | 2.26 | 3.09 | 3.37 | 2.15 | 2.47 | 2.62 |
| Rel. viscosity (Eta rel.) | | | | | | | | | |
| O h, granules | | 1.27 | 1.277 | 1.275 | 1.276 | 1.275 | 1.278 | 1.27 | 1.276 |
| After 50 h boiling test | | 1.22 | 1.274 | 1.271 | 1.231 | 1.233 | 1.275 | 1.27 | 1.223 |
| After 100 h boiling test | | 1.20 | 1.273 | 1.269 | 1.195 | 1.120 | 1.271 | 1.27 | 1.213 |
| Δ Eta rel. after 50 h | | — | −0.003 | −0.004 | −0.045 | −0.042 | −0.003 | 0.00 | −0.053 |
| Δ Eta rel. after 100 h | | — | −0.004 | −0.006 | −0.081 | −0.155 | −0.007 | — | −0.063 |

| Example No.: | 23 | 24 | 25 | 26 | 27 | 28 | 29 |
|---|---|---|---|---|---|---|---|
| Formulation acc. to inv.? | no | yes | yes | no | | yes | |
| PC1 | 95 | 95 | 95 | 95 | 95 | 95 | 95 |
| PC2 | 4.575 | 4.475 | 4.175 | 4.175 | 4.32 | 4.32 | 4.32 |
| PETS | | 0.40 | 0.40 | 0.40 | | | |
| TPP | | 0.025 | 0.025 | | 0.02 | 0.02 | 0.02 |
| Trialkyl phosphite | 0.025 | | | 0.025 | | | |
| Tinuvin 329 | 0.4 | 0.1 | 0.4 | 0.4 | | | |
| Hostavin B-Cap | | | | | 0.25 | 0.25 | |
| Uvinul 3030 | | | | | | | 0.25 |
| GMS | | | | | 0.4 | | 0.4 |
| Loxiol G32 | | | | | | 0.4 | |
| opt. data in 4 mm | | | | | | | |
| Y.I. | 3.31 | 1.81 | 2.32 | 3.27 | 1.56 | 1.71 | 2.5 |
| Rel. viscosity (Eta rel.) | | | | | | | |
| O h, granules | 1.272 | 1.275 | 1.275 | 1.274 | 1.27 | 1.27 | 1.27 |
| After 50 h boiling test | 1.260 | 1.274 | 1.273 | 1.231 | 1.25 | 1.27 | 1.25 |
| After 100 h boiling test | 1.249 | 1.273 | 1.270 | 1.199 | 1.25 | 1.27 | 1.25 |
| Δ Eta rel. after 50 h | −0.012 | −0.001 | −0.002 | −0.043 | — | 0.00 | 0.02 |
| Δ Eta rel. after 100 h | −0.023 | −0.002 | −0.005 | −0.075 | — | 0.00 | 0.02 |

As is clear from the above tables, the compositions according to the invention have a YI of <2.8 and a ΔEta rel. after 100 hours of <0.025.

1.-15. (canceled)

16. A composition comprising a melt polycarbonate and
a) at least one UV absorber,
b) at least one phosphine, and
c) optionally an aliphatic carboxylic acid ester,
wherein the phosphines comprise compounds of formula (I): 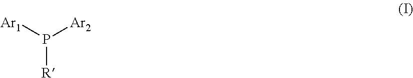
wherein Ar₁ and Ar₂ represent identical or different unsubstituted or substituted aryl radicals and R′ represents an unsubstituted or substituted aryl radical or one of the following radicals (Ia) to (Ih) 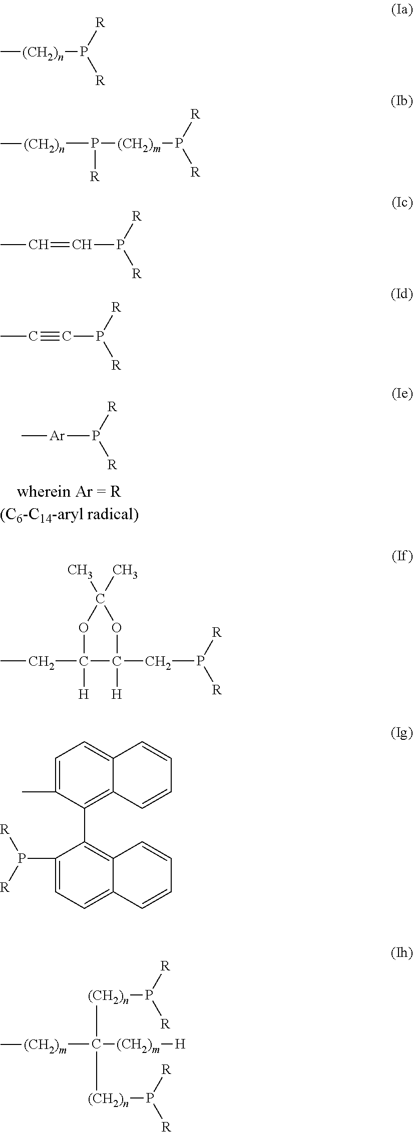
in which R represents an unsubstituted or substituted C₆-C₁₄-aryl radical and n and m each independently of the other is an integer from 1 to 7, and wherein the hydrogen atoms of radicals (Ia) to (Ic) can also be replaced by substituents, and wherein
R′ can also be 4-phenyl-phenyl or α-naphthyl when Ar₁ and Ar₂ in formula (I) are each likewise 4-phenyl-phenyl or α-naphthyl, and wherein the 4-phenyl-phenyl and α-naphthyl radicals can be substituted.

17. The composition according to claim 16, in which the melt polycarbonate comprises a melt polycarbonate of formula (TV) 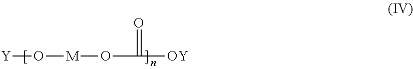
wherein the square brackets denote structural repeating units,
M represents Ar₃ or a multifunctional compound A, B, C and compound D,
wherein Ar₃ can be a compound represented by formula (VIII) or (IX) 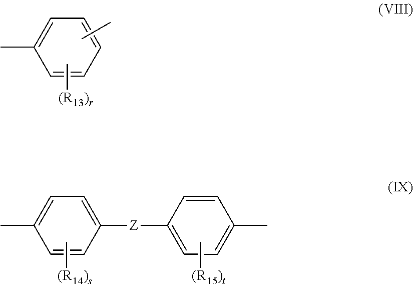
wherein
Z represents C₁- to C₈-alkylidene or C₅- to C₁₂-cycloalkylidene, S, SO₂ or a single bond,
n is a natural number,
R₁₃, R₁₄, R₁₅ independently of one another represent a substituted or unsubstituted C₁-C₁₈-alkyl radical, preferably a substituted or unsubstituted phenyl, methyl, propyl, ethyl, butyl, Cl or Br, and n represents 0, 1 or 2,
r, s, t independently of one another can be 0, 1, 2 or 3,
wherein X represents Y or -[MOCOO]ₙ—Y,
wherein the multifunctional compound A is a compound of the formula 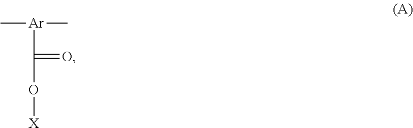
wherein the multifunctional compound B is a compound of the formula 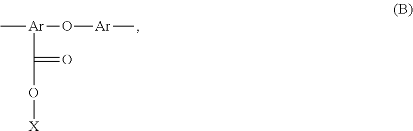
wherein the multifunctional compound C is a compound of the formula 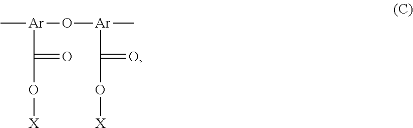
wherein compound D is a compound of the formula 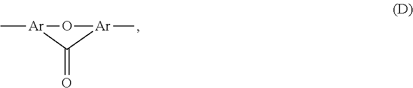
and the sum of multifunctional compounds A, B, C and D is greater than or equal to 5 mg/kg, wherein Y is H or a compound of formula (X) 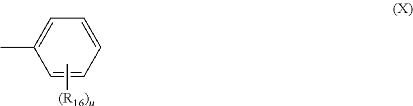
wherein
the radicals R₁₆, which are identical or different, can be H, C₁- to C₂₀-alkyl, C₆H₅ or C(CH₃)₂C₆H₅, and
u can be 0, 1, 2 or 3,
wherein M and Y have the meaning given above.

18. The composition according to claim 16, wherein the UV absorbers are selected from the group consisting of benzotriazoles, triazines, cyanoacrylates or malonic esters.

19. The composition according to claim 16, wherein the UV absorbers are selected from the group consisting of benzotriazoles and malonic esters.

20. The composition according to claim 16, wherein the UV absorbers are employed in amounts of from 0.01 to 15 wt. %, based on the total weight of the composition.

21. The composition according to claim 16, wherein the UV absorbers are employed in amounts of from 0.1 to 0.4 wt. %, based on the total weight of the composition.

22. The composition according to claim 16, wherein the phosphines are employed in amounts of from 10 to 2000 mg/kg, based on the total weight of the composition.

23. The composition according to claim 16, wherein the phosphines are employed in amounts of from 100 to 500 mg/kg, based on the total weight of the composition.

24. The composition according to claim 16, wherein the phosphine comprises triphenylphosphine.

25. The composition according to claim 16, further comprising at least one alkyl phosphate of the general formula (II): 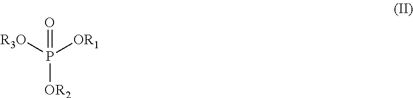
wherein R₁ to R₃ represent H, identical or different linear, branched or cyclic alkyl radicals, mono-, di- or tri-isooctyl phosphate (tri-2-ethylhexyl phosphate) or a mixture thereof.

26. The composition according to claim 16, further comprising an aliphatic carboxylic acid ester of the general formula (III):
(R₄—CO—O)ₒ—R₅—(OH)ₚ (III)
wherein
o is 1 to 4;
p is 3 to 0;
R₄ represents an aliphatic saturated or unsaturated, linear, cyclic or branched alkyl radical and
R₅ represents an alkylene radical of a mono- to tetra-hydric aliphatic alcohol R₅—(OH)ₒ₊ₚ.

27. The composition according to claim 25, wherein the alkyl phosphates are employed in amounts of from 0.5 to 500 mg/kg, based on the total weight of the composition.

28. The composition according to claim 16, wherein the carboxylic acid esters are employed in amounts of from 0 to 12,000 mg/kg, based on the total weight of the composition.

29. The composition according to claim 16, wherein the carboxylic acid esters are employed in amounts of from 2000 to 8000 mg/kg, based on the total weight of the composition.

30. The composition according to claim 16, wherein the YI value of the composition after injection moulding is less than or equal to 2.80 and the fall in the Eta rel. value is less than 0.023 after a 50-hour boiling test and less than 0.025 after 100 hours.

31. A Moulded body comprising the composition according to claim 16.
